(19) United States
(12) Patent Application Publication
(10) Pub. No.: US 2009/0210409 A1
(43) Pub. Date: Aug. 20, 2009

(54) INCREASING ONLINE SEARCH ENGINE RANKINGS USING CLICK THROUGH DATA

(75) Inventor: Michael Levin, New York, NY (US)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 3020, BOCA RATON, FL, 33487, US

(73) Assignee: CKC Communications, Inc. dba Connors Communications, New York, NY (US)

(21) Appl. No.: 12/113,707

(22) Filed: May 1, 2008

Related U.S. Application Data
(60) Provisional application No. 60/915,138, filed on May 1, 2007.

(51) Int. Cl. G06F 17/30

(52) U.S. Cl. 707/5; 707/E17.014

(57) ABSTRACT

A method for providing keywords for a web page so as to increase online search engine rankings of the web page is provided. The method includes detecting click-throughs to the web page from a link in a search result list of an online search engine. The method further includes collecting data for each click-through, including: a) at least one keyword entered into an online search engine by a user to produce the search result list from which the click-through originated and b) a position value. The method further includes assigning a score to each keyword based on a number of words in the keyword and position values associated with each keyword. The method further includes providing keywords with a score that meets a predefined threshold as a suggestion for improving search engine rankings of the web page.

### CROSS-REFERENCE TO RELATED APPLICATIONS

The present U.S. patent application claims priority to U.S. Provisional Patent Application No. 60/915,138 filed on May 1, 2007 and entitled “Improved Placement in Web Search Results.” U.S. Provisional Patent Application No. 60/915,138 is hereby incorporated by reference in its entirety.

### BACKGROUND OF THE INVENTION

1. Field of the Invention

The present invention relates to search engines, and more particularly to improved methods for optimizing web site data in order to achieve higher online search engine rankings.

2. Description of the Related Art

The use of online search engines has become ubiquitous in today's society. It is common for people to use online search engines as a primary method of locating companies, suppliers of goods and services, web sites, and other information.

Typically, a web surfer will enter a word or phrase into a search engine, which in turn performs a search and responds with a list of search results that include links to web pages containing, or relevant to, the word or phrase entered. Companies and other entities are eager to have links to their web sites appear higher on the list of search results. Online search engines determine which web sites to rank highly, or list high, in the search results, based on algorithms that use some parameters that are not directly controllable by the web site owner.

As a source of revenue, online search engines may list a company's web site in the advertising portion of search results for a fee. Thus, if an advertising fee is paid, a company can guarantee that its web site will be shown as a search result responsive to certain search terms being entered at the online search engine. The portion of online search engine results that is determined by paid advertising is known as search engine marketing. This practice of buying one's way into search results has grown to become an $11 billion per year industry.

However, the practice of paying for higher rankings in search results, called pay per click (PPC) advertising, can be costly. In addition, many people tend to ignore the for-pay search results, focusing instead on the genuine search results, often referred to as natural or organic listings. In short, organic listings comprise that portion of online search engine results that is solely determined editorially by algorithms and search engine optimization methods and are not affected by paid advertising such as PPC. This difference between for-pay search results and organic search results creates an imbalance in the market, and a demand for a new type of product capable of securing the coveted unpaid-for search result positions and more cost-effective paid advertisements.

With regard to organic search results, keywords are often a major factor affecting online search engine rankings. A keyword is a word, phrase or alphanumerical term included in a web page in either a visible or non-visible manner. Online search engine marketers often focus on selecting the right keyword(s) to bring in the right audience and thereby lead to the best return on marketing dollars. This is usually accomplished through the manual process of search engine optimization. Undergoing a manual process to effectuate such a procedure, however, can be time consuming, error-prone and costly.

Keywords are also highly pertinent to the long tail product market. The “long tail” is the colloquial name for a long-known feature of statistical distributions. In these distributions, a high-frequency or high-amplitude population is followed by a low-frequency or low-amplitude population which gradually “tails off.” In many cases the infrequent or low-amplitude events—the long tail—can cumulatively outnumber or outweigh the initial portion of the graph, such that in aggregate they compromise the majority. Products that are in low demand or have low sales volume can collectively make up a market share that rivals or exceeds the relatively few current bestsellers and blockbusters, if the store or distribution channel is large enough. Thus, in the retail industry, the “long tail” can be a lucrative market and the distribution and sales channel opportunities created by the web often enable businesses to tap into this market successfully. Because of the low demand and niche nature of products in the long tail, it is desirable to facilitate web users in finding a web retailer that provides such a product. To this end, it becomes important for a web site publisher to select the right keyword(s) to bring in the audience desiring his long tail products.

There remains a need for a more efficient way to select keywords for web pages or web sites so as to target a particular audience or market via online search engines. More particularly, there remains a need for a reliable, sustainable, long-term and automated method of increasing web site traffic from qualified prospective customers by identifying which keywords will yield the best position in organic search results for online search engines.

### BRIEF SUMMARY OF THE INVENTION

Embodiments of the present invention address deficiencies of the art in respect to online search engine rankings and provide a novel and non-obvious method, computer system and computer program product for facilitating selection of keywords so as to increase search engine rankings. In one embodiment of the invention, a method for providing keywords for a web page so as to increase online search engine rankings of the web page is provided. The method includes detecting click-throughs to the web page from a link in a search result list of an online search engine. The method further includes collecting data for each click-through, including: a) at least one keyword entered into an online search engine by a user to produce the search result list from which the click-through originated and b) a position value that defines a position within the search result list in which the link originating the click-through was located. The method further includes assigning a score to each keyword collected, wherein a score is based on a number of words in the keyword and position values associated with each keyword. The method further includes identifying a first set of keywords with a score that meets a predefined threshold and providing the first set of keywords as a suggestion for improving search engine rankings of the web page.

In another embodiment of the invention, a method for providing keywords for a web page so as to increase online search engine rankings of the web page is provided. The method includes detecting a click-through to the web page from a link in a search result list of an online search engine. The method further includes collecting data for the click-through, including: a) at least one keyword entered into the online search engine by a user to produce the search result list and b) a position value that defines a position within the search result list in which the link was located. The method further includes assigning a score to each keyword, wherein a score is based on the position value associated with each keyword and identifying a first set of keywords with a score that meets a predefined threshold. The method further includes providing the first set of keywords as a suggestion for improving search engine rankings of the web page.

In another embodiment of the invention, a computer program product comprising a computer usable medium embodying computer usable program code for providing keywords for a web page so as to increase online search engine rankings of the web page is provided. The computer program product includes computer usable program code for detecting click-throughs to the web page from a link in a search result list of an online search engine. The computer program product further includes computer usable program code for collecting data for each click-through, including: a) at least one keyword entered into an online search engine by a user to produce the search result list from which the click-through originated and b) a position value that defines a position within the search result list in which the link originating the click-through was located. The computer program product further includes computer usable program code for assigning a score to each keyword collected, wherein a score is based on a number of words in the keyword and position values associated with each keyword and computer usable program code for identifying a first set of keywords with a score that meets a predefined threshold. The computer program product further includes computer usable program code for providing the first set of keywords as a suggestion for improving search engine rankings of the web page.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a network architecture for an automated keyword suggestion system for increasing search engine rankings, according to one embodiment of the present invention; and

FIG. 2 is a flow chart depicting a process for collecting click-through data, according to one embodiment of the present invention.

### DETAILED DESCRIPTION OF THE INVENTION

Embodiments of the present invention address deficiencies of the art in respect to online search engine rankings and provide a novel and non-obvious method and computer program product for facilitating selection of keywords so as to increase search engine rankings. A method for providing keywords for a web page so as to increase online search engine rankings of the web page is provided. The method includes detecting click-throughs to the web page from a link in a search result list of an online search engine. The method further includes collecting data for each click-through, including: a) at least one keyword entered into an online search engine by a user to produce the search result list from which the click-through originated and b) a position value that defines a position within the search result list in which the link originating the click-through was located. The method further includes assigning a score to each keyword collected, wherein a score is based on a number of words in the keyword and position values associated with each keyword. The method further includes identifying a first set of keywords with a score that meets a predefined threshold and providing the first set of keywords as a suggestion for improving search engine rankings of the web page.

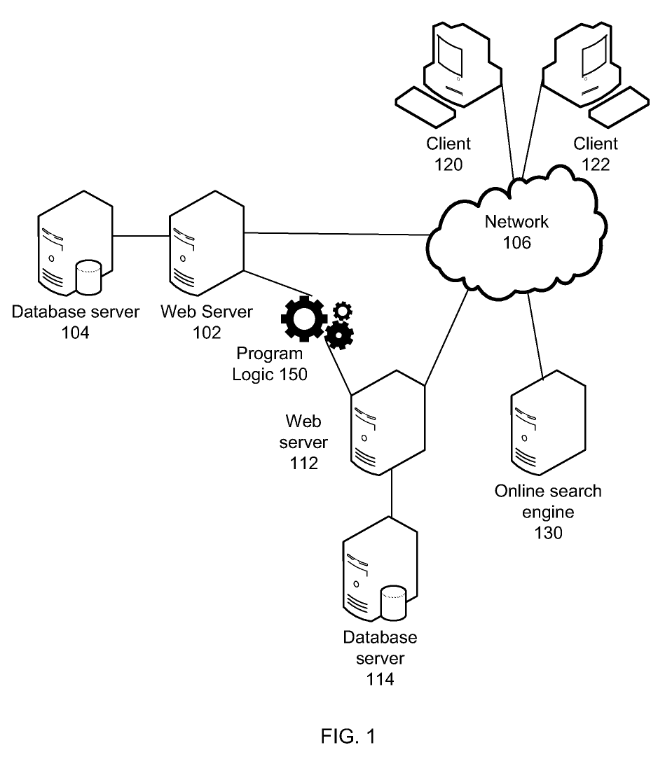

FIG. 1 is a block diagram illustrating a network architecture for an automated keyword suggestion system for increasing search engine rankings, according to one embodiment of the present invention. FIG. 1 shows multiple clients, users or web surfers 120-122, each including a computer used to access a network 106, such as the Internet or the World Wide Web. The computers of web surfers 120-122 may be a personal computer, a server, a workstation, a smart phone, or a personal digital assistant. Also connected to the network 106 is a web server of a web site publisher 102 and a web server of an administrator 112. Web servers 102, 112 may be any commercially available web server, such as the IBM HTTP Server available from International Business Machines, Corp. of Armonk, N.Y.

Web server 102 may optionally include a database server 104 that serves data from a database, which is a repository for web site data used by web server 102 during the course of operation. The database of database server 104 may adhere to any one of the flat model, hierarchical model, object-oriented model or a relational model for databases. The database server 104 may also include a database management system, which is an application that controls the organization, storage and retrieval of data (fields, records and files) in the database. A database management system accepts requests for data from the web server 102, and instructs the operating system to transfer the appropriate data. The database management system may also control the security and integrity of the database. Data security prevents unauthorized users from viewing or updating certain portions of the database. The description above for database server 104 also applies to database server 114 except that the database of database server 114 is a repository for click-through data collected by the program logic 150.

It should be noted that although FIG. 1 shows the distributed computing environment comprising only web servers 102, 112, online search engine 130 and client computers 120-122, the system of the present invention supports any number of servers, search engines and client computers as comprising the distributed computing environment. It should also be noted that although the functions of web and database servers 102 and 104 are depicted as being separate, in one embodiment of the present invention, the functions of servers 102 and 104 are integrated into one server. Similarly, while the functions of web and database servers 112 and 114 are also depicted as being separate, in one embodiment of the present invention, the functions of servers 112 and 114 are integrated into one server.

In one embodiment of the present invention, the web server of web site publisher 102 includes a program logic 150 comprising computer instructions for tracking click-throughs to the web site publisher 102 and storing related data, as described in greater detail below. In another embodiment of the present invention, program logic 150 may include computer instructions for analyzing collected click-through data and presenting suggestions for keywords in order to increase search engine rankings of the web site of publisher 102, also as described in greater detail below. In additional embodiments of the present invention, program logic 150 may reside fully on the web server of administrator 112 or may reside in a distributed fashion on a combination of web servers 102 and 112.

Program logic 150, or any portion thereof, may comprise a scripting language code or interpreted language code such as Perl, PHP, server-side VBScript, JavaScript, or client-side JavaScript. Program logic 150, or any portion thereof, may be embedded in web page source code (such as HTML code) served by the web server of web site publisher 102.

FIG. 1 further shows that online search engine 130 is connected to network 106. A web surfer 120 may enter search terms or keywords into a web site of online search engine 130, thereby spawning a search and the provision of a list of search results by online search engine 130, wherein the search results include a list of links. By clicking on one of the links, the web surfer 120 initiates a click-through to the web site of web site publisher 102. The program logic 150 captures certain data from the click-through, such as the IP address of the web surfer 120, the URL of online search engine 130, the web site name of the online search engine 130, the URL of the page to which the originating link referred the web surfer 120, the geographic location of the web surfer 120, the search terms or keywords entered by the web surfer 120, the number of keywords entered by the web surfer 120 and a position value that defines a position within the search results in which the link originating the click-through was located. One example of a position value is a pages-in value that defines a number of pages within the search results in which the link originating the click-through was located.

Collected click-through data may be transmitted to web server 112 and stored in the database of database server 114. Upon accessing of the web site of web site publisher 102 by web surfer 120, the web server 102 serves web site data from database server 104 to the web surfer 120.

Subsequent to the gathering of click-through data, program logic 150 analyzes the collected click-through data using an algorithm to determine whether keyword suggestions shall be given to an administrator or web programmer for web site publisher 102 so as to increase search engine rankings of the web site of web site publisher 102. If so, program logic 150 produces a report that includes a list of keywords that may increase the search engine rankings of the web site of web site publisher 102. This report may be viewed by an administrator or a web programmer via an interface such as a web browser or a standalone windows application. The data in the report may then be used to either add to or edit the web site content of web site publisher 102 using the suggested keywords and/or to purchase the suggested keywords in a PPC campaign so as to increase the search engine rankings of the web site.

In an alternative to online search engine 130, the web surfer 120 enters search terms or keywords into an interface for another type of web site, such as a blog, a social networking site, a video download site or an email client interface.

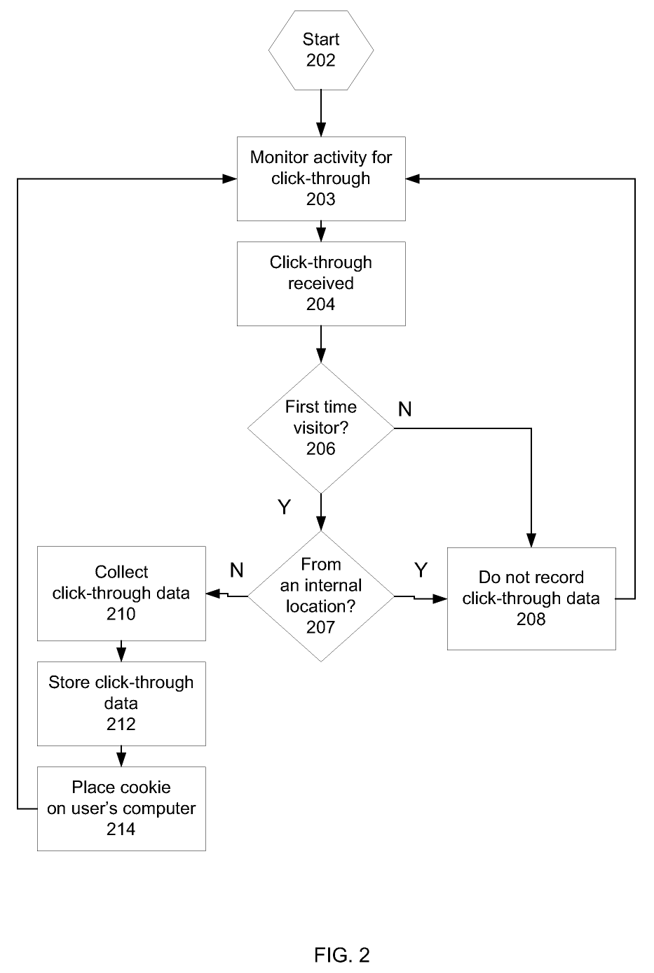

FIG. 2 is a flow chart depicting a process for collecting click-through data, according to one embodiment of the present invention. FIG. 2 provides more detail regarding the process by program logic 150 collects click-through data, as first described above with reference to FIG. 1. The flow chart of FIG. 2 begins with step 202 and moves directly to step 203. In step 203, the web site of web site publisher 102 monitors activity for all click-throughs originating from any web site.

In step 204, the web site of web site publisher 102 receives an HTTP request from web surfer 120 for web site data responsive to a click-through from an originating web site, such as online search engine 130. In step 206, the program logic 150 determines whether the web surfer 120 is a first time visitor (in the current browsing session) to the web site of web publisher 102 via a previous click-through. Program logic 150 may accomplish this step by seeking a cookie on the computer of web surfer 120, which cookie was previously placed by program logic 150 on a previous visit by web surfer 120 during the current browsing session and which cookie indicates that the web surfer 120 has previously visited the web site of web publisher 102 via a previous click-through in the current browsing session. If the result of the determination of step 206 is negative, then control flows to step 208. Otherwise, control flows to step 207.

In step 207, the program logic 150 determines whether the current click-through originated from an internal location, such as a web page from the web site of web site publisher 102, instead of an external location, such as an online search engine such as 130. Program logic 150 may accomplish this step by reading information in the HTTP request to the web site of web site publisher 102. If the result of the determination of step 207 is negative, then control flows to step 210. Otherwise, control flows to step 208.

In step 208, the click-through data for the current click-through is not recorded and control flows back to step 203. In step 210, the program logic 150 captures certain data from the click-through, as described above. In step 212, collected click-through data may be transmitted to web server 112 and stored in the database of database server 114. In step 214, a cookie is placed on the computer of web surfer 120, wherein the cookie indicates that the web surfer 120 has previously visited the web site of web publisher 102 via a previous click-through in the current browsing session. Subsequently, control flows back to step 203.

In one embodiment of the present invention, the click-through data stored in the database of database server 114 includes a plurality of records, wherein each record includes a collected keyword, a counter (that defines a number of times the keyword has been collected) and at least one position value. In this embodiment of the present invention, the step 212 further comprises determining whether, for each keyword collected from the click-through of step 210, the keyword has been collected previously and stored in the database of database server 114. If so, then the counter for the record of the previously collected keyword in the database of database server 114 is incremented by one. If not, then a new record is created in the database server 114, wherein the record includes the keyword, a counter set to one and the position value of the keyword.

In one embodiment of the present invention, each keyword stored in the database of database server 114 includes a plurality of assigned scores and/or a total score. In this embodiment of the present invention, the step 212 further comprises assigning a score to each keyword collected from the click-through of step 210, wherein the score is based on the position value associated with the keyword and the number of words comprising the keyword. A position value, such as a pages-in value, is a good indicator of whether a keyword is effective in increasing search engine rankings since a keyword that results in a pages-in value of one indicates a high search ranking and a keyword that results in a pages-in value of fifteen indicates a low search ranking. Similarly, the number of words comprising the keyword is a good indicator of whether a keyword can be effective in increasing search engine rankings since a keyword with fewer words are more likely to be used than keywords with many words.

In this embodiment, when a record for a keyword is created, then a score for that keyword is calculated and stored in connection with the keyword. Similarly, each time the counter for the record of the keyword is incremented, then an additional score for that keyword is calculated and stored in connection with the keyword. A total score for a keyword may comprise an amalgamation of all scores stored in the record for the keyword, such as an average of all scores.

The records of keywords with a total score or scores that meet a predefined threshold represent keywords that can be used to optimize the web site of web server 102 for online search engines. Program logic 150 may produce a report that includes a list of keywords meeting the predefined threshold, wherein the selected keywords may increase the search engine rankings of the web site of web site publisher 102. This report may be viewed by an administrator or a web programmer via an interface such as a web browser or a standalone windows application. The data in the report may then be used to either edit the web site content of web site publisher 102 using the suggested keywords or to purchase the suggested keywords in a PPC campaign so as to increase the search engine rankings of the web site.

Alternatively, an administrator or web programmer can select an option by which the suggested keywords can be used to automatically add to or edit the web site content of web site publisher 102 using the suggested keywords or to automatically purchase the suggested keywords in a PPC campaign so as to increase the search engine rankings of the web site.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for providing keywords for a web page so as to increase online search engine rankings of the web page, comprising:
detecting click-throughs to the web page from a link in a search result list of an online search engine;
collecting data for each click-through, including: a) at least one keyword entered into an online search engine by a user to produce the search result list from which the click-through originated and b) a position value that defines a position within the search result list in which the link originating the click-through was located;
assigning a score to each keyword collected, wherein a score is based on a number of words in the keyword and position values associated with each keyword;
identifying a first set of keywords with a score that meets a predefined threshold; and
providing the first set of keywords as a suggestion for improving search engine rankings of the web page.

2. The method of claim 1, wherein the step of detecting further comprises:
determining whether each click-through is a first time click-through to the web page for a current browsing session; and
forgoing collection of data for any click-through if it is not a first time click-through to the web page for the current browsing session.

3. The method of claim 1, wherein the step of detecting further comprises:
transmitting a cookie to a web browser of the user initiating a click-through if it is a first time click-through to the web page for the current browsing session, wherein the cookie indicates that a first time click-through has occurred.

4. The method of claim 3, wherein the step of detecting further comprises:
determining whether each click-through is a first time click-through to the web page for a current browsing session by seeking a cookie on the user's computer indicating that a first time click-through has occurred; and
forgoing collection of data for any click-through if it is not a first time click-through to the web page for the current browsing session.

5. The method of claim 1, wherein the step of providing further comprises:
providing a user interface for displaying for an administrator the first set of keywords as a suggestion for improving search engine rankings of the web page;
receiving from an administrator a selection of keywords from the first set for automated processing; and
automatically modifying the web page so as to include the selection of keywords or creating a pay per click campaign including the selection of keywords.

6. A method for providing keywords for a web page so as to increase online search engine rankings of the web page, comprising:
detecting a click-through to the web page from a link in a search result list of an online search engine;
collecting data for the click-through, including: a) at least one keyword entered into the online search engine by a user to produce the search result list and b) a position value that defines a position within the search result list in which the link was located;
assigning a score to each keyword, wherein a score is based on the position value associated with each keyword;
identifying a first set of keywords with a score that meets a predefined threshold; and
providing the first set of keywords as a suggestion for improving search engine rankings of the web page.

7. The method of claim 6, wherein the step of detecting further comprises:
determining whether the click-through is a first time click-through to the web page for a current browsing session; and
forgoing collection of data for the click-through if it is not a first time click-through to the web page for the current browsing session.

8. The method of claim 6, wherein the step of detecting further comprises:
transmitting a cookie to a web browser of the user initiating the click-through if it is a first time click-through to the web page for the current browsing session, wherein the cookie indicates that a first time click-through has occurred.

9. The method of claim 8, wherein the step of detecting further comprises:
determining whether the click-through is a first time click-through to the web page for a current browsing session by seeking a cookie on the user's computer indicating that a first time click-through has occurred; and
forgoing collection of data for the click-through if it is not a first time click-through to the web page for the current browsing session.

10. The method of claim 6, wherein the step of providing further comprises:
providing a user interface for displaying for an administrator the first set of keywords as a suggestion for improving search engine rankings of the web page;
receiving from an administrator a selection of keywords from the first set for automated processing; and
automatically modifying the web page so as to include the selection of keywords or creating a pay per click campaign including the selection of keywords.

11. A computer program product comprising a computer usable medium embodying computer usable program code for providing keywords for a web page so as to increase online search engine rankings of the web page comprising:
computer usable program code for detecting click-throughs to the web page from a link in a search result list of an online search engine;
computer usable program code for collecting data for each click-through, including: a) at least one keyword entered into an online search engine by a user to produce the search result list from which the click-through originated and b) a position value that defines a position within the search result list in which the link originating the click-through was located;
computer usable program code for assigning a score to each keyword collected, wherein a score is based on a number of words in the keyword and position values associated with each keyword;
computer usable program code for identifying a first set of keywords with a score that meets a predefined threshold; and
computer usable program code for providing the first set of keywords as a suggestion for improving search engine rankings of the web page.

12. The computer program product of claim 11, wherein the computer usable program code for detecting further comprises:
computer usable program code for determining whether each click-through is a first time click-through to the web page for a current browsing session; and
computer usable program code for forgoing collection of data for any click-through if it is not a first time click-through to the web page for the current browsing session.

13. The computer program product of claim 11, wherein the computer usable program code for detecting further comprises:
computer usable program code for transmitting a cookie to a web browser of the user initiating a click-through if it is a first time click-through to the web page for the current browsing session, wherein the cookie indicates that a first time click-through has occurred.

14. The computer program product of claim 13, wherein the computer usable program code for detecting further comprises:
computer usable program code for determining whether each click-through is a first time click-through to the web page for a current browsing session by seeking a cookie on the user's computer indicating that a first time click-through has occurred; and
computer usable program code for forgoing collection of data for any click-through if it is not a first time click-through to the web page for the current browsing session.

15. The computer program product of claim 11, wherein the computer usable program code for providing further comprises:
computer usable program code for providing a user interface for displaying for an administrator the first set of keywords as a suggestion for improving search engine rankings of the web page;
computer usable program code for receiving from an administrator a selection of keywords from the first set for automated processing; and
computer usable program code for automatically modifying the web page so as to include the selection of keywords or creating a pay per click campaign including the selection of keywords.

16. A computer program product comprising a computer usable medium embodying computer usable program code for providing keywords for a web page so as to increase online search engine rankings of the web page comprising:
computer usable program code for detecting a click-through to the web page from a link in a search result list of an online search engine;
computer usable program code for collecting data for the click-through, including: a) at least one keyword entered into the online search engine by a user to produce the search result list and b) a position value that defines a position within the search result list in which the link was located;
computer usable program code for assigning a score to each keyword, wherein a score is based on the position value associated with each keyword;
computer usable program code for identifying a first set of keywords with a score that meets a predefined threshold; and
computer usable program code for providing the first set of keywords as a suggestion for improving search engine rankings of the web page.

17. The computer program product of claim 16, wherein the computer usable program code for detecting further comprises:
computer usable program code for determining whether the click-through is a first time click-through to the web page for a current browsing session; and
computer usable program code for forgoing collection of data for the click-through if it is not a first time click-through to the web page for the current browsing session.

18. The computer program product of claim 16, wherein the computer usable program code for detecting further comprises:
computer usable program code for transmitting a cookie to a web browser of the user initiating the click-through if it is a first time click-through to the web page for the current browsing session, wherein the cookie indicates that a first time click-through has occurred.

19. The computer program product of claim 18, wherein the computer usable program code for detecting further comprises:
computer usable program code for determining whether the click-through is a first time click-through to the web page for a current browsing session by seeking a cookie on the user's computer indicating that a first time click-through has occurred; and
computer usable program code for forgoing collection of data for the click-through if it is not a first time click-through to the web page for the current browsing session.

20. The computer program product of claim 16, wherein the computer usable program code for providing further comprises:
computer usable program code for providing a user interface for displaying for an administrator the first set of keywords as a suggestion for improving search engine rankings of the web page;
computer usable program code for receiving from an administrator a selection of keywords from the first set for automated processing; and
computer usable program code for automatically modifying the web page so as to include the selection of keywords or creating a pay per click campaign including the selection of keywords.
